(19) United States
(12) Patent Application Publication
(10) Pub. No.: US 2026/0184030 A1
(43) Pub. Date: Jul. 2, 2026

(54) METHOD FOR PRODUCING SEAMLESS BIMETAL BLOCK

(71) Applicant: GIANT GLORY INTERNATIONAL LIMITED, Apia (WS)

(72) Inventor: Cheng-Ping HSIAO, Pingtung County (TW)

(21) Appl. No.: 19/274,951

(22) Filed: Jul. 21, 2025

(30) Foreign Application Priority Data
Dec. 27, 2024 (TW) 113151149

(51) Int. Cl. B29C 70/84; B29C 70/68; B29K 705/00

(52) U.S. Cl. CPC B29C 70/84; B29C 70/681; B29K 2705/00

(57) ABSTRACT

A method for producing a seamless bimetal block includes the steps of: providing a first metal block and a second metal block, the first metal block including a bottom portion and a sidewall portion; providing a mold including a lower mold, and placing the first metal block into the lower mold so that the lower mold, the bottom portion, and the sidewall portion jointly define a bonding space; forming a bonding unit in the bonding space, the bonding unit including a first sharp portion, and a second sharp portion; and disposing the second metal block on top of the second sharp portion, covering the lower mold to press the second metal block, and performing an ultrasonic welding so as to melt the first sharp portion and the second sharp portion, the first metal block and the second metal block being joined together to obtain the seamless bimetal block.

### CROSS-REFERENCE TO RELATED APPLICATION

This application claims priority to Taiwanese Invention Patent Application No. 113151149, filed on December 27, 2024, the entire disclosure of which is incorporated by reference herein.

### FIELD

The disclosure relates to a method for producing a seamless bimetal block at room temperature.

### BACKGROUND

As consumers pay greater attention to the appearance of electronic products, e.g., computers, communication devices, or consumer electronics, the appearance design of electronic products is increasingly valued by the industry. In order to enhance the aesthetics, a cover shield of a conventional electronic product may be made by bonding of two different metals. Because different metals have different corrosion potentials, when an electrolyte simultaneously comes in contact with two different metallic materials contacting each other, Galvanic corrosion may occur, causing corrosion to one of the two different metallic materials that serves as an anode. As a result, a bonding medium is usually required to be disposed between the two different metallic materials in order to avoid the occurrence of Galvanic corrosion.

At present, a commonly used bimetal bonding method is plastic injection molding technique, in which a polymer material is used as a bonding medium between two metals to ensure that the two metals do not come into direct contact with each other after bonding. However, since the temperature adopted in the plastic injection molding technique ranges from 120°C to 160°C, if there is a large difference between thermal expansion coefficients of two metals to be bonded, thermal deformation is likely to occur, which may adversely affects precision and size of an electronic product obtained from such bimetal bonding method.

### SUMMARY

Therefore, an object of the disclosure is to provide a method for producing a seamless bimetal block that can alleviate at least one of the drawbacks of the prior art. The method includes the steps of:

providing a first metal block and a second metal block, the first metal block including a bottom portion and a sidewall portion, the bottom portion having a flat surface, the sidewall portion extending upward from a periphery of the flat surface, wherein the flat surface and the sidewall portion of the first metal block, and the second metal block are roughened;

providing a mold including a lower mold and a mold cover, and placing the first metal block into the lower mold with the sidewall portion abutting one side of an inner surface of the lower mold so that the lower mold, the bottom portion, and the sidewall portion jointly define a bonding space, a volume of the second metal block being less than a volume of the bonding space, a height of the second metal block being less than a height of the sidewall portion;

forming a bonding unit made of a polymer material in the bonding space and on the flat surface, the bonding unit including a bonding body, a first sharp portion, and a second sharp portion, the bonding body being in contact with the flat surface, and having a first welding surface that is adjacent to the sidewall portion and located below a top surface of the sidewall portion, and a second welding surface that is located below the first welding surface, the first sharp portion being located on the first welding surface, the second sharp potion being located on the second welding surface; and

disposing the second metal block on top of the second sharp portion located on the second welding surface, covering the lower mold with the mold cover to press the second metal block, and performing an ultrasonic welding to melt the first sharp portion and the second sharp portion so that the mold cover fully closes the lower mold and so that the first sharp portion and the second sharp portion which are molten fill interspaces between the first metal block, the second metal block, and the bonding body, the first metal block and the second metal block being joined together to obtain the seamless bimetal block.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a flow chart illustrating an embodiment of a method for producing a seamless bimetal block according to the present disclosure.

FIGS. 2A to 2E are schematic diagrams illustrating consecutive processing steps of the method according to the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

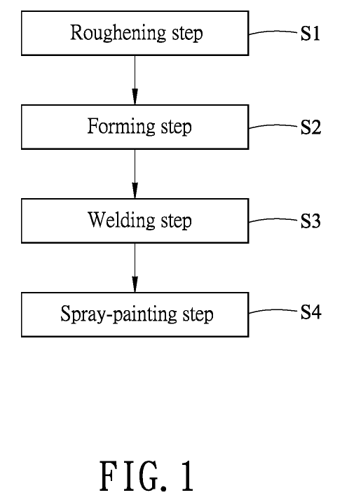

Referring to FIG. 1, an embodiment of a method for producing a seamless bimetal block according to the present disclosure includes a roughening step (S1), a forming step (S2), a welding step (S3), and a spray-painting step (S4).

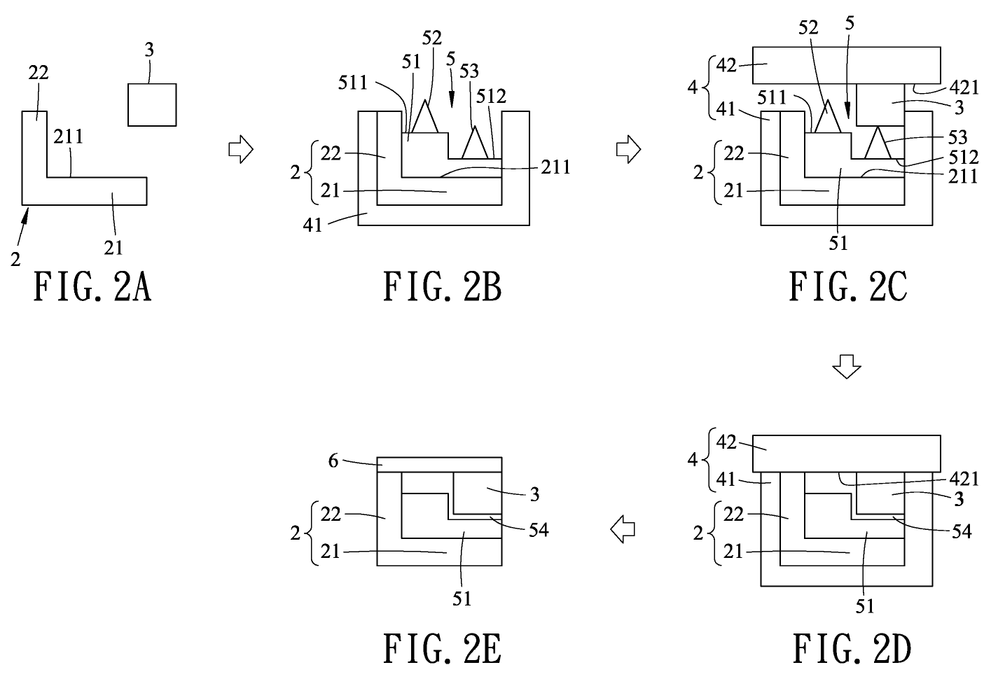

Referring to FIG. 2A, in the roughening step (S1), a first metal block 2 and a second metal block 3 are provided. The first metal block 2 includes a bottom portion 21 and a sidewall portion 22. The bottom portion 21 has a flat surface 211, and the sidewall portion 22 extends upward from a periphery of the flat surface 211, such that a cross-section of the first metal block 2 is L-shaped. The second metal block 3 is in a cubic shape. In addition, the flat surface 211 and the sidewall portion 22 of the first metal block 2, and the second metal block 3 are roughened.

Specifically, in the roughening step (S1) of this embodiment, a conventional nano-molding technology (NMT) is adopted. That is to say, initially, the flat surface 211, a surface of the sidewall portion 22 connected to the flat surface 211, and surfaces of the second metal block 3 are subjected to acid etching, so as to form a plurality of nano-sized pits thereon. Subsequently, by utilizing the “T treatment” developed by Taisei Plas Co., Ltd., amine compounds (such as hydrazine hydrate, ethylenediamine, a carbamate, etc.) can remain in the nano-sized pits, allowing a chemical reaction between the amine compounds and polar groups of a polymer material, which is used in plastic embedding or plastic injection molding conducted subsequently, to proceed. The nano-molding technology is well known to those skilled in the art, and detailed description thereof is not provided herein.

Referring to FIGS. 2B and 2C, the forming step (S2) is conducted as follows. First, a mold 4, which includes a lower mold 41 and a mold cover 42, is provided. The first metal block 2 with the flat surface 211 being roughened is then placed into the lower mold 41 with the sidewall portion 22 abutting one side of an inner surface of the lower mold 4 so that the lower mold 41, the bottom portion 21, and the sidewall portion 22 jointly define a bonding space. A volume of the second metal block 3 is less than a volume of the bonding space, and a height of the second metal block 3 is less than a height of the sidewall potion 22. The lower mold 41 has a top open end, and the mold cover 42 has a cover inner surface 421 to contact the top open end when the lower mold 41 is fully closed by the mold cover 42. The bonding space is formed between the sidewall portion 22 of the first metal block 2 and another side of the inner surface of the lower mold 41 opposite to the sidewall portion 22 and between the cover inner surface 421 and the flat surface 211 of the first metal block 3.

Subsequently, a bonding unit 5 made of the polymer material is formed in the bonding space and on the flat surface 211. The bonding unit 5 includes a bonding body 51, a first sharp portion 52, and a second sharp portion 53. The bonding body 51 is in contact with the flat surface 211, and has a first welding surface 511 that is adjacent to the sidewall portion 22 and located below a top surface of the sidewall portion 22, and a second welding surface 512 that is distant from the sidewall portion 22 and located below the first welding surface 511, thus allowing a cross-section of the bonding body 51 to be in step-shaped. A surface of the bonding body 51 that is connected to the flat surface 211 abuts against the sidewall portion 22 of the first metal block 2, and another surface (opposite to the aforesaid surface) of the bonding body 51 that is connected to the flat surface 211 abuts against a surface of the lower mold 41. The first sharp portion 52 is located on the first welding surface 511, and the second sharp portion 53 is located on the second welding surface 512.

To be specific, the bonding unit 5 made of the polymer material is formed on the flat surface 211 that is roughened through conventional plastic embedding or plastic injection molding. For example, the bonding unit 5 may be formed on the flat surface 211 in the bonding space of the mold 4 by introducing the polymer material into the bonding space and by using an upper mold (not shown) which has an upper mold inner surface to press and shape the polymer material, so as to obtain the bonding unit 5 with a configuration shown in FIG. 2B and 2C. The cross-section of the bonding body 51 is in step-shaped, and forms two planer surfaces (i.e., the first and second welding surfaces 511, 512) with different height levels. In addition, the first sharp portion 52 and the second sharp portion 53 are each in a shape of a triangular pyramid, and are formed on the first welding surface 511 and the second welding surface 512, respectively. The polymer material may be selected from polyphenylene sulfide (PPS), polybutylene terephthalate (PBT), polycarbonate (PC), or polyamide (PA), and the polar groups of the polymer material chemically react with the amine compounds remaining in the nano-sized pits, so that the bonding unit 5 made of the polymer material can be firmly bonded to the flat surface 211 of the first metal block 2 that is roughened.

It should be noted that, in some embodiments, the roughening step (S1) may be conducted by simply forming roughened microstructures on the flat surface 211, the surface of the sidewall portion 22 connected to the flat surface 211, and surfaces of the second metal block 3 through a physical or chemical method, without the need of conducting the “T treatment” for leaving amine compounds on these surfaces. Formation of the roughened microstructures can also enhance bonding and adhesion of the first sharp portion 52 and the second sharp portion 53 after being melted.

Referring to FIGS. 2C and 2D, in the welding step (S3), first, the second metal block 3 is disposed on top of the second sharp portion 53 (that is, at this time, the position of the second metal block 3 is correspondingly located above the second sharp portion 53) located on the second welding surface 512. Thereafter, the lower mold 41 is covered with the mold cover 42 to continuously press the second metal block 3, and an ultrasonic welding is performed simultaneously to melt the first sharp portion 52 and the second sharp portion 53, and also to melt the sides of the bonding body 51 in contact with the first metal block 2, such that the mold cover 42 can be continuously lowered to contact a top surface of the lower mold 41 and to fully close the lower mold 41. After the mold 4 is fully closed, the first sharp portion 52 and the second sharp portion 53 that are molten fill interspaces between the first metal block 2, the second metal block 3, and the bonding body 51, thus permitting the first metal block 2 and the second metal block 3 to be joined, thereby obtaining the seamless bimetal block. The first sharp portion 52 and the second sharp portion 53, after being melted, form a caulking part 54 that binds the first metal block 2 and the second metal block 3 together and that fills the aforesaid interspaces, so that the first metal block 2, the second metal block 3, and the bonding unit 5 are combined to form an integral block (i.e., the seamless bimetal block). In addition, the integral block thus obtained has top surfaces of the first metal block 2, the caulking part 54, and the second metal block 3 being flush with each other. It should be noted that, when the bonding body 51, the first sharp portion 52, and the second sharp portion 53 are made of the same material, the caulking portion 54 formed after melting of the first sharp portion 52 and the second sharp portion 53 can be integrated with the bonding body 51, so that the first metal block 2 and the second metal block 3 are jointly bonded to each other.

The aforesaid ultrasonic welding is a technology that utilizes ultrasonic waves to melt the polymer material, and hence can be conducted at room temperature (that is, without additional heat treatment), thereby effectively reducing thermal influence upon different metals compared to when the different metals are joined together by conventional plastic embedding. Additionally, a total volume of the bonding unit 5 and the second metal block 3 is equal to the volume of the bonding space. Therefore, the first sharp portion 52 and the second sharp portion 53, after being melted, can completely fill the interspaces between the first metal block 2, the second metal block 3, and the bonding body 51 after the mold 4 is closed, so as to achieve seamless joining of two metals.

Finally, referring to FIG. 2E, in the spray-painting step (S4), a surface of the integral block is spray painted so as to form a paint layer 6, thereby obtaining a finished product.

Specifically, the spray-painting step (S4) is conducted by taking out the integral block from the mold 4, followed by spray painting a top surface of the integral block (i.e., the top surfaces of the first metal block 2, the caulking part 54, and the second metal block 3 that face the mold cover 42 of the mold 4) to form the paint layer 6, thereby obtaining the finished product. The finished product thus obtained has an appearance of surface integrity through formation of the paint layer 6, by which the integral block can be further protected, and hence the finished product has enhanced resistance to corrosion.

In summary, by virtue of the ultrasonic welding adopted in the method for producing the seamless bimetal block according to the present disclosure, melting of the polymer material (specifically, the first and second sharp portions 52, 53) can be conducted at room temperature so as to avoid thermal deformation of the materials disposed in a mold, which may occur in the conventional high temperature plastic embedding process for bonding different metals having different thermal expansion coefficients. In addition, by having pointed structures, i.e., the first and second sharp portions 52, 53, the polymer material can be more easily melted by ultrasonic welding to fill the interspaces between the first metal block 2 and the second metal block 3, and to form a bonding medium (i.e., the caulking part 54) between the first metal block 2 and the second metal block 3. Moreover, a surface of the finished product after bonding of the first metal block 2 and the second metal block 3 is flat, thereby achieving seamless joining of two metals.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for producing a seamless bimetal block, comprising the steps of:
providing a first metal block and a second metal block, the first metal block including a bottom portion and a sidewall portion, the bottom portion having a flat surface, the sidewall portion extending upward from a periphery of the flat surface, wherein the flat surface and the sidewall portion of the first metal block, and the second metal block are roughened;
providing a mold including a lower mold and a mold cover, and placing the first metal block into the lower mold with the sidewall portion abutting one side of an inner surface of the lower mold so that the lower mold, the bottom portion, and the sidewall portion jointly define a bonding space, a volume of the second metal block being less than a volume of the bonding space, a height of the second metal block being less than a height of the sidewall portion;
forming a bonding unit made of a polymer material in the bonding space and on the flat surface, the bonding unit including a bonding body, a first sharp portion, and a second sharp portion, the bonding body being in contact with the flat surface, and having a first welding surface that is adjacent to the sidewall portion and located below a top surface of the sidewall portion, and a second welding surface that is located below the first welding surface, the first sharp portion being located on the first welding surface, the second sharp portion being located on the second welding surface; and
disposing the second metal block on top of the second sharp portion located on the second welding surface, covering the lower mold with the mold cover to press the second metal block, and performing an ultrasonic welding to melt the first sharp portion and the second sharp portion so that the mold cover fully closes the lower mold and so that the first sharp portion and the second sharp portion which are molten fill interspaces between the first metal block, the second metal block, and the bonding body, the first metal block and the second metal block being joined together to obtain the seamless bimetal block.

2. The method as claimed in claim 1, wherein the first sharp portion and the second sharp portion, after being melted, form a caulking part that binds the first metal block and the second metal block together.

3. The method as claimed in claim 2, wherein top surfaces of the first metal block, the caulking part, and the second metal block are flush with each other.

4. The method as claimed in claim 2, further comprising spray painting top surfaces of the first metal block, the caulking part, and the second metal block so as to obtain a paint layer.

5. The method as claimed in claim 1, wherein the bonding unit on the flat surface is formed by plastic embedding or plastic injection molding.

6. The method as claimed in claim 1, wherein a total volume of the bonding unit and the second metal block is equal to the volume of the bonding space.

7. The method as claimed in claim 1, wherein a cross-section of the first metal block is L-shaped.

8. The method as claimed in claim 1, wherein a cross-section of the bonding body is step-shaped.

9. The method as claimed in claim 1, wherein the ultrasonic welding is performed at room temperature.

10. The method as claimed in claim 1, wherein the lower mold has a top open end, the mold cover having a cover inner surface to contact the top open end when the lower mode is fully closed by the mold cover, the bonding space being formed between the sidewall portion of the first metal block and another side of the inner surface of the lower mold opposite to the sidewall portion and between the cover inner surface and the flat surface of the first metal block.
